(19) United States
(12) Patent Application Publication
(10) Pub. No.: US 2010/0295198 A1
(43) Pub. Date: Nov. 25, 2010

(54) APPARATUS AND METHOD FOR LINING A PIPE

(75) Inventor: LARRY W. KIEST, JR., Ottawa, IL (US)

Correspondence Address: MCKEE, VOORHEES & SEASE, P.L.C., 801 GRAND AVENUE, SUITE 3200, DES MOINES, IA, 50309-2721, US

(73) Assignee: LMK ENTERPRISES, INC., Ottawa, IL (US)

(21) Appl. No.: 12/468,299

(22) Filed: May 19, 2009

(51) Int. Cl. B29C 73/02; B05B 13/06

(52) U.S. Cl. 264/36.17; 118/317

(57) ABSTRACT

An apparatus and method for lining a damaged portion of a pipeline is disclosed. An inverting tubular liner is resin impregnated while in the pipeline in need of repair. An inverting end of the liner is received by a dispensing unit that dispenses resin under pressure to the inverting face of the liner. The liner is then pressed against the damaged section of the pipe until the resinous material cures and hardens.

### BACKGROUND OF THE INVENTION

The present invention relates to an apparatus and a method for lining an interior surface of pipe.

A method presently used for repairing pipelines includes the use of a liner tube having a felt layer on its inside and having a protective layer made of a polymer or other plastic material on its outside. The lining tube is vacuum-impregnated with a resinous material capable of curing and hardening in what is commonly referred to as a “wet-out” process. The wet-out process normally takes place in a wet-out facility, which may be at or remote from the job site. Just prior to wetting-out the liner, a catalyst is mixed with a resin so as to activate the resin and cause it to begin curing and hardening. The resin impregnated liner tube is then moved from the wet-out facility to an operative position wherein the liner tube can be inverted into the pipeline. Once the resin cures and hardens, the liner tube provides a new lining for the pipeline. Some resins are set to cure at ambient temperatures. In some instances, steam or hot water is applied inside the lining tube to speed the cure time.

One problem with the present method is that the catalyst must be mixed with the resin before the liner tube is wet-out and before positioning the liner tube at the damaged section of pipe. Once the catalyst is applied to the resin, the resin begins curing and time is of the essence in order to have the liner tube in place within the pipeline to be repaired. If the resin hardens before the liner tube is properly positioned within the pipe, it may require that a portion of the existing pipeline be dug up and replaced. If, on the other hand, a resin mix with a longer cure time is used to ensure adequate working time to install the liner, productivity suffers as the crew waits for the liner to cure and harden. Aside from the loss in productivity, additional costs are involved in maintaining a separate wet-out facility. There are also additional costs associated with retarding or accelerating the cure time. For example, following the wet-out process the lining tube can be packed in ice and stored in a refrigerator compartment of a truck or trailer to retard or prevent the resin from curing. To accelerate the cure time, a large boiler or other heat source is required at the job site. Such equipment and the additional labor increases the cost of the liner installation.

Therefore, a primary object, feature and/or advantage of the present invention is the provision of an improved method for repairing a damaged section of a pipeline.

A further object, feature and/or advantage of the present invention is a new apparatus and method for lining a pipe that does not require a wet-out facility.

A further object, feature and/or advantage of the present invention is a new apparatus and method for lining a pipe that allows a lining tube to be vacuum impregnated while in the pipeline.

A still further object, feature and/or advantage of the present invention is the provision of a new pipelining system that does not require a bladder.

A further object, feature and/or advantage of the present invention is the provision of a new apparatus and method for lining a pipe that is unaffected by ground water and other materials in the host pipe.

A still further object, feature and/or advantage of the present invention is a new lining method that allows for extremely fast cure times to greatly improve productivity.

Yet a further object, feature and/or advantage of the present invention is the provision of a new apparatus and method of pipeline repair wherein a resinous material is applied to the liner in a controlled environment while in the pipe in need of repair.

A further object, feature and/or advantage of the present invention is the provision of a new method and means for repairing a damaged section of pipe that is more cost-effective than prior art methods.

These and/or other objects, features and/or advantages of the invention will become apparent with reference to the remainder of the specification and claims.

### BRIEF SUMMARY OF THE INVENTION

One aspect of the invention includes a method of rehabilitating a damaged section of pipe that generally includes taking an elongated tubular liner, taking a dispensing unit adapted to receive a portion of the liner, inverting the liner in the pipe with an inverting end of the liner received by the dispensing unit, applying a pumpable material capable of curing and hardening from the dispensing unit to the inverting end of the liner as the liner inverts within the pipe, and pressing the liner against the damaged section of pipe until the resinous material cures and hardens.

In a preferred form, the pumpable material is a resinous material, and a dry liner substantially free of any resinous material is inverted into the pipe and the resinous material is applied under pressure to the inverting end of the liner tube. The liner is preferably maintained in a compressed state until it reaches the inverting end wherein the liner tube decompresses and absorbs the resinous material applied under pressure by the dispensing unit. The lining tube preferably includes a fabric layer that is resin impregnable and a plastic coating that is impermeable thereby allowing the bladder to be pressurized during the inversion process.

Another aspect of the invention includes an assembly for lining an interior of a pipe. The assembly generally includes a feeding pump, a static mixer in communication with the feeding pump for mixing a resin catalyst to form a resin mix, and a dispensing unit adapted to receive an inverting end of an elongated tubular liner and dispense the resin mix under pressure to the inverting end of the liner. Preferably, the dispensing unit is operatively connected to a first reel and first motor and the liner is operatively connected to a second reel and second motor wherein the reels are electronically controlled and in communication with one another to control the way in which the liner and dispensing unit move along the interior of the pipe. The nozzle may include a flexible end portion adapted to move around irregular surfaces on the interior of the pipe.

The present invention allows a dry liner to be wet-out or eventually vacuum impregnated within the pipeline in a controlled environment. This allows the use of a resinous material with an aggressive cure time, which greatly improves productivity. In addition, a separate wet-out facility is no longer required. The present invention also obviates the need for heating and cooling sources to be provided at the job site to either retard or accelerate the cure time of the resinous material.

The present invention contemplates repair of all kinds of pipelines, including, but not limited to, mainline sewer pipelines, lateral sewer pipelines, gas pipelines and potable water pipelines.

### BRIEF DESCRIPTION OF THE DRAWINGS

FIG. 1 is a schematic view illustrating a preferred embodiment of the present invention utilized for repairing a main pipeline extending between two manholes.

FIG. 2 is a schematic view similar to FIG. 1, further illustrating the preferred lining process of the present invention.

FIG. 3 is an enlarged view of a dispensing unit with an inverting liner taken from FIG. 2.

FIG. 4 is an enlarged side view of the dispensing unit with static mixer and nozzle for use according to a preferred embodiment of the present invention.

FIG. 5 is an enlarged sectional view of a pressurized reel with tubular liner loaded therein for use in a preferred embodiment of the present invention.

### DETAILED DESCRIPTION OF THE PREFERRED EMBODIMENTS

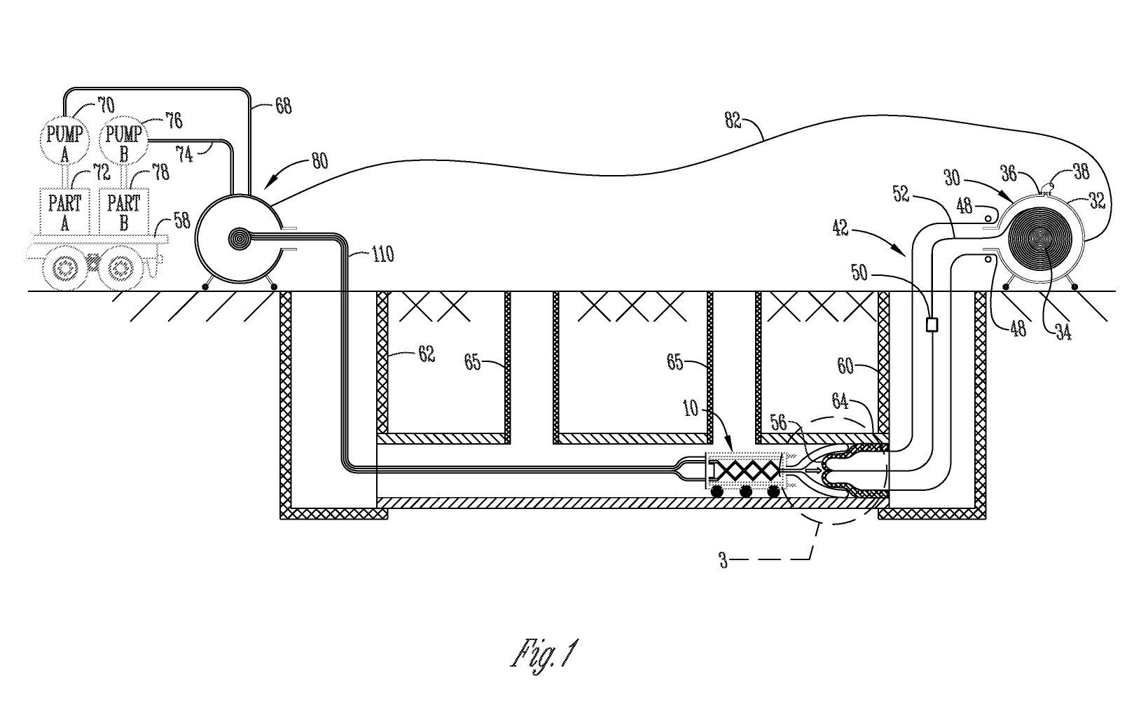

Referring to FIG. 1, a main pipeline 64 is shown extending between a downstream manhole 62 and an upstream manhole 60. While the present invention is shown for use with sewer pipeline repair, the present invention can be utilized for repairing other types of pipes, ducts, tunnels and shafts, such as gas, water, oil, steam and compressed air pipe.

Adjacent the downstream manhole 62 is a truck 58 having resin pump A 70 and a reservoir A 72 and catalyst pump B 76 and a reservoir B 78 mounted thereon. Hose 68 and hose 74 extend from the reservoirs A 72 and B 78, respectively, down to a static mixer 28 housed within a small tractor 10 shown within the pipeline 64. The hoses 68 and 74 may also include electronic cables for controlling the tractor 10.

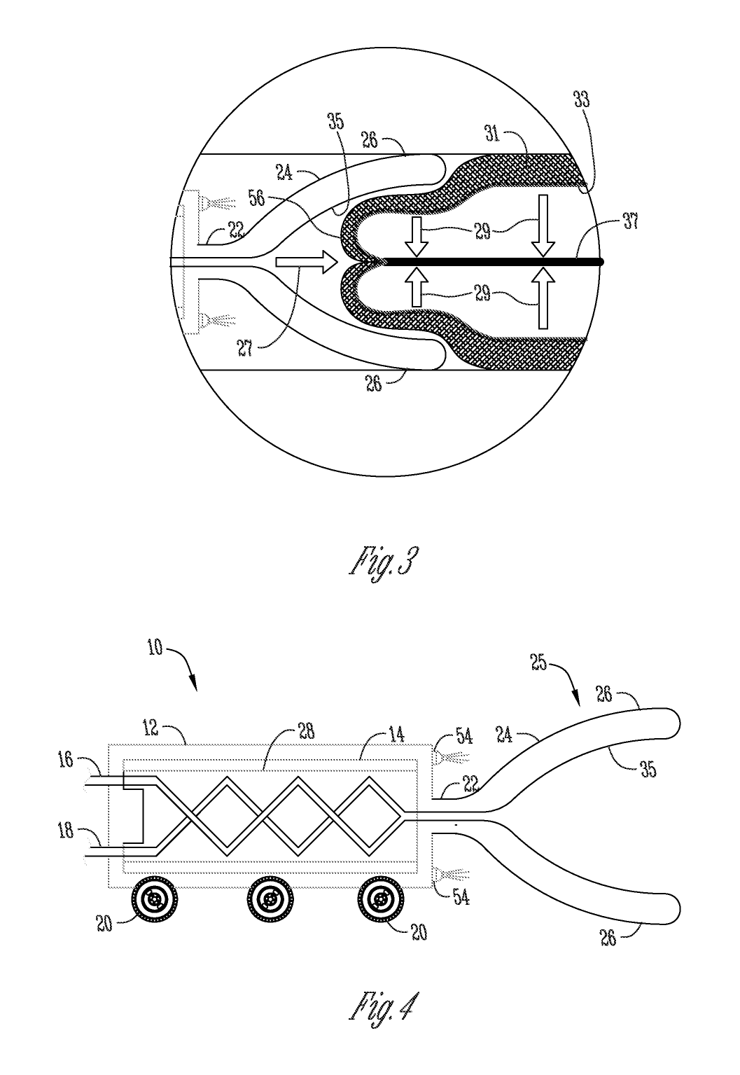

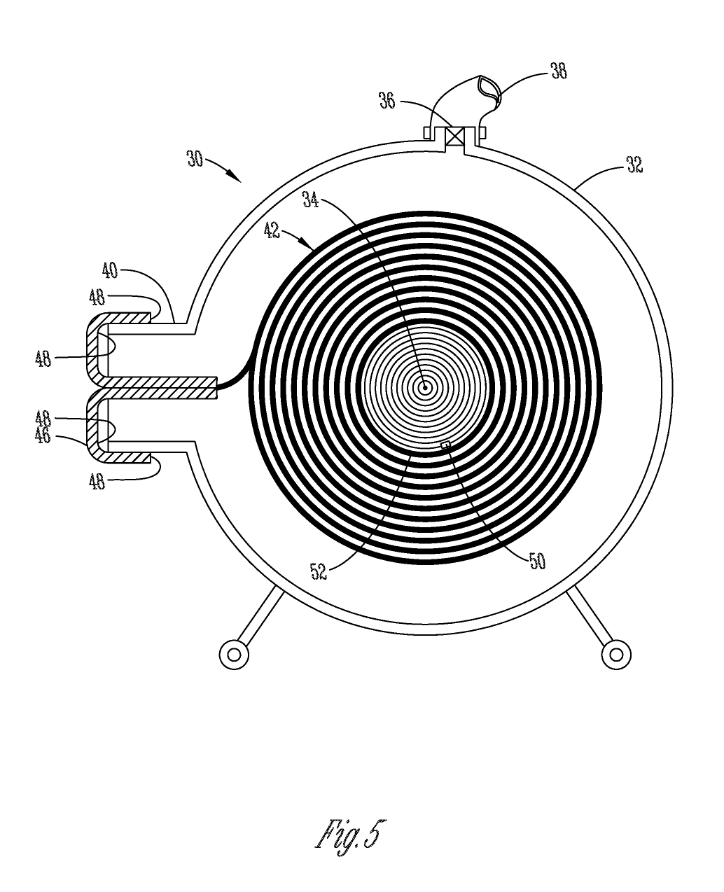

FIG. 4 shows the tractor 10 and dispensing unit 25 extending therefrom. Tractors such as the one shown are commonly used in the pipeline repair industry and are capable of moving along the length of the pipeline 64. The tractor 10 shown includes a tractor housing 12, wheels 20 and cameras 54. The static mixer 28, disposed within a static mixer housing 14, is positioned within the tractor housing 12. The dispensing unit 25 comprises a nozzle which is fluidly connected to an output 22 from the static mixer 28 for applying a resin mixture on the interior of the pipeline 64. The nozzle of the dispensing unit 25 includes a flexible end portion 26, which allows the nozzle to accommodate changes in diameter and protrusions along the interior wall of the pipeline 64. The flexible end portion 26 is preferably formed of a material like rubber and, if necessary, can be removed and replaced after each application. As shown in FIG. 3 the nozzle of the dispensing unit 25 forms an internal cavity with a circular end portion. The resinous material is forced under pressure through the output 22 of the static mixer 28 and into the center of the nozzle in the direction shown by the arrow 27. As described later in the specification, the nozzle applies the resinous material to an inverting face 56 of a liner tube 42 to resin impregnate the liner tube in the pipe 64 as the liner tube is inverting.

A two-part resin including a resin with a catalyst is an example of a pumpable material capable of curing that is suitable for use with the present invention. The suitable resin mixture is an epoxy resin set at a 1:1 resin to catalyst mix ratio, Rhino Linings product no. 1310T. Rhino Linings is located at 9090 Kenamar Drive, San Diego, Calif. USA 92121. A single component resin, such as a UV cured resin, could also be used, which would obviate the need for a static mixer 26 as shown. Many variations of resinous liquid polymers are available for use with the invention and the resin and catalyst mixture may range from 1:1 to 100:2. The later range would be more typical when using a polyester resin rather than an epoxy resin. Other pumpable materials may be used with the invention such as mortors or other pumpable materials capable of being impregnated into the liner tube and curing to form a rigid new pipe lining.

The preferred two-part resin is pumped from pump A 70 and pump B 76 to inputs 16 and 18 of the static mixer 28. The resin is fed via hose 68 to input 16 and the catalyst is fed via hose 74 to input 18 and completely mixed within the static mixer 28. The resulting mixture is distributed from output 22 of the static mixer 28 and into the interior cavity of the nozzle of the dispensing unit 25.

Static mixers incorporate a series of geometric mixing elements that are made from metal or a variety of plastics fixed within a cylindrical (tube) or squared housing, which use the energy of the flow stream to create mixing between two or more fluids. Likewise, the mixer housing can be made from metal or plastic. Typical materials of construction for the static mixer components include clear PVC, gray PVC, stainless steel, ductile iron, polypropylene, Teflon, Kynar, fiberglass and polyacetal.

Hoses 68 and 74 are wound through a take-up reel 80 outside and above the downstream manhole 62. The hoses 68 and 70 are banded as designated by the reference numeral 110. In addition to acting as a conduit for the pumpable material, the banded hoses 110 also help to properly position and move the dispensing unit 25 along the pipeline 64. The take-up reel 80 controls the length the banded hoses 110.

Outside and above the upstream manhole 60 is a pressurized reel 30 which contains an outer cylindrical housing 32 and a center roller 34. A pressure inlet valve 36 in the housing 32 provides communication from the interior of the housing to a pressure hose 38. Pressure hose 38 is preferably connected to a pneumatic source of pressurized air. However, other fluids could be used without detracting from the invention.

The pressurized reel is shown in greater detail in FIG. 5. The valve 36 is movable from an open position permitting pressurized fluid (preferably air) to be introduced to the interior of pressurized reel 30 to a closed position shutting off communication of pressurized fluid from the interior of the pressurized reel 30. The reel 30 includes an inverting boss 40 on one of its sides upon which may be mounted an inflatable liner tube designated generally by the numeral 42.

The liner tube 42 is comprised of a felt layer 31 and a plastic layer 33 (see FIG. 3), as is known in the art. The felt layer 31 is adapted to absorb a liquid resin, and the plastic layer 33 is adapted to provide an impervious smooth continuous surface. Prior to inverting the liner tube 42, the plastic layer 33 is located on the outside of the liner tube 42 and the felt layer 31 is located on the inside. During the inversion process which will be described below, the liner tube 42 is inverted so that the felt layer 31 is on the outside of the liner tube and the smooth plastic layer 33 is on the inside of the liner tube. Use of an impermeable coating on the liner tube 42 allows the liner tube to be inflated and inverted without the use of a separate bladder.

Referring again to FIG. 5, a rope 52 is wound around the center roller 34 within the pressurized reel 30. Sufficient rope must be included to go the entire length of the damaged portion of the pipeline 64 to be repaired. The liner tube 42 is fed through circular rollers to compress the liner tube, removing the air in the areas between the felt fabric fibers. The closed end 50 of the liner tube 42 is attached to the end of the rope 52 and then wound or wrapped on itself around the center roller 34 until its complete length is taken up. Wrapping the liner tube 42 on itself as shown maintains the felt layer 31 of the liner tube in a compressed state. The open end 48 of the liner tube 42 is fitted over the boss 40 and is clamped in place so as to have an airtight connection therearound. As shown in FIG. 4, the open end 48 of the liner tube 42 is folded back upon itself much in the same fashion as the peeling off of a sock.

In operation, the liner tube 42 must be properly positioned initially relative to the dispensing unit 25. A length of the liner tube 42 is dropped into the upstream manhole 60 adjacent the opening to the main pipeline 64. An operator in the manhole 60 can then position the inverting face 56 of the liner tube 42 inside the nozzle of the dispensing unit 25. The inverting face 56 of the liner tube 42 should extend at least partially into the cavity of the nozzle adjacent the dispensing area for the resin mix. The valve 36 is then moved to its open position and fluid pressure, preferably air, as introduced into the interior of the reel 30 such that the liner tube 42 inflates and the pull rope 52 becomes taught. Similarly, the banded hose lines 110 running to the tractor 10 are also pulled taught by the take up reel 80. The resin and catalyst are then pumped from the truck 58 through lines 110 and through the output 22 of the static mixer 28 and through the nozzle of the dispensing unit 25.

Once the resin mix is dispensing into the nozzle of the dispensing unit 25, the reels 80 and 30 are put into a sync mode such that the dispensing unit 25 travels at substantially the same pace and is in synch with the inverting face 56 of the liner tube 52. The reels 80 and 30 are smart reels that communicate electronically with each other through a data cable 82, as is known in the art. Each reel is operatively connected to a motor. The motors are preferably DC motors, and one of the motors may be positioned within the pressurized reel vessel. It is preferable that the rotational speed of the take up reel 80 be slightly less than the rotational speed of the pressurized reel 30, as this avoids the inverting face 56 of the liner tube 42 separating from the dispensing unit 25. The force applied by the inverting liner tube 42 helps push the dispensing unit through the pipeline 64 as the reel 80 takes up the slack in the banded hose lines 110. The resinous material also acts as a natural lubricant on an inner surface 35 the dispensing unit 25, as the liner tube 42 moves against the inner surface.

FIG. 1 shows a small section of the liner tube 42 inverted with the resin impregnated felt layer compressed against the interior of the pipeline 64. FIG. 3 shows in greater detail the structural relationship between the liner tube 42 and the nozzle dispensing resin as the liner tube becomes impregnated with resin and inverts along the pipeline 64. As described previously, the liner tube 42 is compressed and then wrapped on itself in the pressurized reel 30. When the liner tube 42 is pressurized and inflates during the inversion process, the tail portion 37 of the liner tube remains compressed under opposing forces acting in the direction shown by arrows 29. When the liner tube 42 reaches its inverting end, the felt layer 31 decompresses and absorbs the resin mix, which is preferably applied to the liner tube under pressure. This has several advantages. It allows the liner tube 42 to essentially be vacuum impregnated with resin while in the pipe, thus obviating the need for a separate wet-out operation above ground. In addition, as the liner tube 42 inverts, it provides a seal against the inner surface 35 of the dispensing unit 25 to create a controlled area to impregnate the liner tube with resin. As such, the resin impregnation process is unaffected by ground water or other materials in the pipeline 64. Further yet, because of the catalyst is introduced using a static mixer 28 immediately prior to dispensing the resin mix around the interior of the pipe 64, a resin mix having a very short or aggressive cure time at ambient temperatures can be used, thus greatly improving productivity and cycle time for the operation.

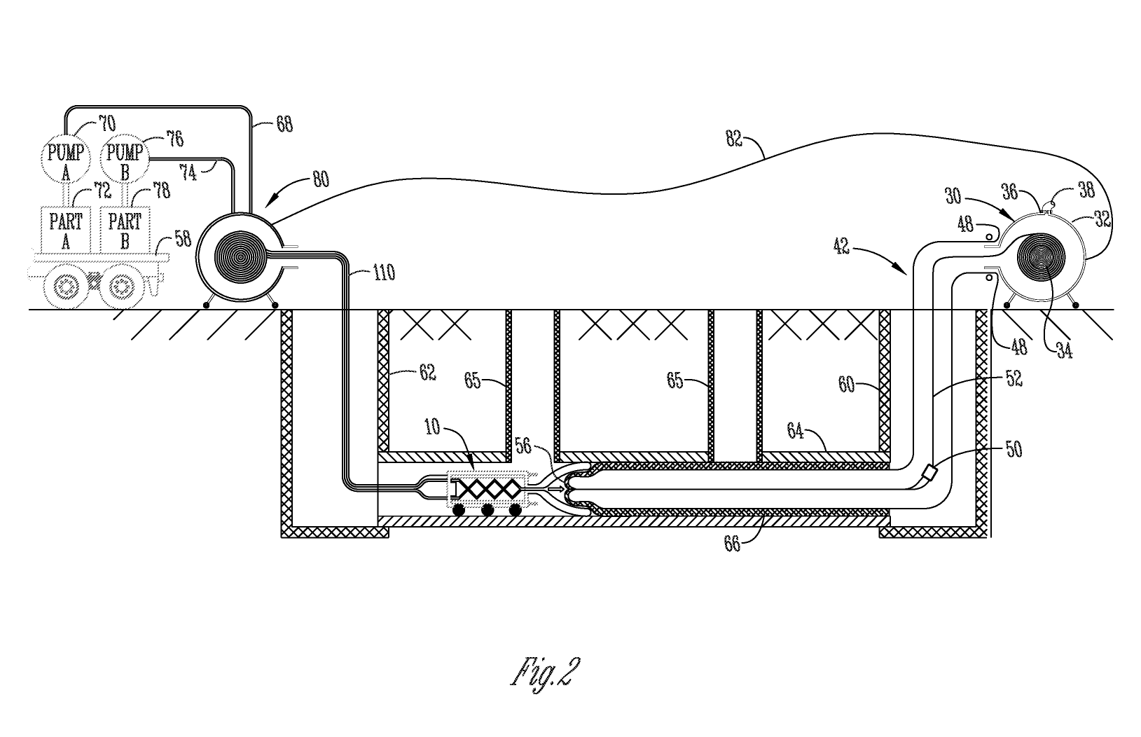

FIG. 2 shows the dispensing unit and the liner tube 42 after the assembly has moved along a portion of the pipeline 64. The service connections to the lateral pipes 65 must be later reinstated using a robotic cutter or the like. Once the liner tube 42 fully inverts, the liner tube is maintained under pressure until the resin mix fully cures and hardens. The leading end of the liner tube is then cut at the opening to the upstream manhole 60.

As disclosed previously, a rope 52 is attached to the liner tube 42. However, one could use a hose rather than the rope 52. The hose could be attached to a vacuum pump. As the dry liner tube 42 is loaded into the pressurized reel 30, a vacuum is drawn, and the vacuum kept on during inversion of the liner tube 42.

In a preferred form of the invention, a separate bladder tube is not used to inflate the liner tube 42; however, a bladder tube can also be inverted with the liner tube, if desired. This would eliminate the need for a plastic coating or layer 33 on the liner tube 42.

Those skilled in the art, having the benefit of this disclosure, will appreciate the numerous advantages achieved by the present invention. Of course, no separate bladder is required. In addition, the present invention avoids the problems associated with wetting out a liner and either retarding or accelerating the cure rate to accommodate the “working” time. Workers are often constrained by working time. There is limited amount of time to get the liner in place after the resin is mixed. The liner must be wetted out and installed before it cures. Once the liner is properly positioned within the pipe, then it is preferable to speed up the curing process, which may be done by introducing steam, heat, etc. Using the present invention, the wet out process essentially occurs within the pipe and a fast cure time is therefore appropriate. That is, the use of the present invention enables an aggressive cure schedule, which greatly improves productivity. And because the liner tube 42 stays compressed until reaching the inverting end where it decompresses and the resin mix applied under pressure in a controlled environment, the resin is applied well throughout the liner tube.

In the drawings and specification there has been set forth a preferred embodiment of the invention, and although specific terms are employed, these are used in a generic and descriptive sense only and not for purposes of limitation. Changes in the form and the proportion of parts as well as in the substitution of equivalents are contemplated as circumstances may suggest or render expedient without departing from the spirit or scope of the invention as further defined in the following claims.

What is claimed is:

1. A method of rehabilitating a damaged section of pipe comprising:
taking an elongated tubular liner;
taking a dispensing unit adapted receive a portion of the liner;
inverting the liner in the pipe with an inverting end of the liner disposed at least partially within the dispensing unit;
applying a pumpable material from the dispensing unit to the inverting end of the liner as the liner inverts within the pipe, the pumpable material capable of curing and hardening; and
pressing the liner against the damaged section of pipe until the resinous material cures and hardens.

2. The method of claim 1 wherein the pumpable material is a resinous material.

3. The method of claim 2 wherein the dispensing unit and the inverting end of the liner move substantially in sync along the damaged section of pipe.

4. The method of claim 3 wherein the inverting end of the liner seals against an inner surface of the dispensing unit to create a cavity for applying the pumpable material.

5. The method of claim 1 further comprising compressing the liner prior to applying the pumpable material to the inverting end of the liner.

6. The method of claim 5 wherein the liner includes a resin impregnable fabric layer and an impermeable coating, the pumpable material being applied to the fabric layer at the inverting end of the liner.

7. The method of claim 6 wherein the pumpable material is not applied to the liner until the liner reaches the inverting end.

8. The method of claim 1 wherein the pumpable material is applied to the inverting end of the liner under pressure.

9. A method of rehabilitating a damaged section of pipe comprising:
taking a dispensing unit adapted to dispense a resinous material capable of curing and hardening;
taking an elongated tubular liner;
compressing the liner tube;
positioning an inverting end of the liner at least partially within the dispensing unit;
inverting the liner along the damaged section of pipe with the inverting end of the liner disposed at least partially within the dispensing unit;
decompressing the liner tube as the liner tube reaches the inverting end;
applying a resinous material under pressure from the dispensing unit to the inverting end of the liner as the liner inverts within the pipe; and
pressing the liner with resinous material against the damaged section of pipe until the resinous material cures and hardens.

10. The method of claim 9 wherein the dispensing unit and the inverting end of the liner move substantially in sync along the damaged section of pipe.

11. The method of claim 10 wherein the inverting end of the liner seals against an inner surface of the dispensing unit to create a cavity for applying the resinous material.

12. The method of claim 9 wherein the liner includes a resin impregnable fabric layer and an impermeable coating, the resinous material being applied under pressure to the fabric layer at the inverting end of the liner.

13. The method of claim 9 wherein the resinous material is not applied to the liner until the liner reaches the inverting end.

14. The method of claim 9 wherein the liner is pressurized during the inverting step and a non-inverting tail portion of the liner is maintained in a compressed state.

15. An assembly for lining an interior of a pipe comprising:
a feeding pump;
a static mixer having an inlet and an outlet, the inlet being in fluid communication with the feeding pump for mixing a resin and a catalyst to form a resin mix;
a dispensing unit in fluid communication with the outlet of the static mixer, the dispensing unit having a nozzle adapted to dispense the resin mix under pressure in the pipe;
an elongated tubular liner having an inverting end adapted to engage the nozzle of the dispensing unit and receive the resin mix under pressure;
wherein the dispensing unit being operatively connected to a first reel and first motor and the liner being operatively connected to a second reel and second motor, the first and second reels being electronically controlled to control the rate at which the liner and the dispensing unit move along the interior of the pipe.

16. The assembly of claim 15 wherein the liner is adapted to move substantially sync with the dispensing unit along the interior of the pipe.

17. The assembly of claim 15 wherein the nozzle includes a flexible end portion adapted to move around irregular surfaces on the interior of the pipe.
